(19) United States
(12) Patent Application Publication
(10) Pub. No.: US 2026/0035306 A1
(43) Pub. Date: Feb. 5, 2026

(54) SYSTEMS AND METHODS FOR PRODUCING GRAPHITE

(71) Applicant: Charm Industrial, Inc., San Francisco, CA (US)

(72) Inventor: Edward Young, Albany, CA (US)

(21) Appl. No.: 19/287,495

(22) Filed: Jul. 31, 2025

Related U.S. Application Data
(60) Provisional application No. 63/678,251, filed on Aug. 1, 2024.

(51) Int. Cl. C04B 35/532; B01J 6/00; C01B 32/205; C04B 35/64; C25B 1/135; C25B 9/09

(52) U.S. Cl. CPC C04B 35/532; B01J 6/008; C01B 32/205; C04B 35/64; C25B 1/135; C25B 9/09; C04B 2235/3418; C04B 2235/425; C04B 2235/48

(57) ABSTRACT

In various examples, the subject matter of this disclosure relates to methods and systems for producing graphite. An example method includes: obtaining biochar; forming the biochar into a pellet; immersing the pellet and an anode in a molten salt electrolyte; and applying a voltage difference across the pellet and the anode to form graphite.

### CROSS-REFERENCE TO RELATED APPLICATIONS

This application claims the benefit of U.S. Provisional Patent Application No. 63/678,251, filed on Aug. 1, 2024, the entire contents of which are incorporated by reference herein.

### TECHNICAL FIELD

This disclosure generally relates to graphitization and, in certain examples, to systems and methods for producing graphite from biochar using electrochemical processing.

### BACKGROUND

Currently, graphite is either synthesized or obtained from natural deposits. Some carbon materials (e.g., coke and mesophase pitch) can be transformed to graphite by heating and are thus referred to as “graphitizable.” For example, synthetic graphite for Li-ion batteries can be made using blends of high-purity graphitizable carbons, extrusion, repeated carbonization (e.g., baking at 800-1000° C.), pitch impregnation, and finally graphitization. Many common graphite synthesis approaches, however, are environmentally detrimental and highly energy intensive, for example, requiring processing at about 3000° C. for several days. These approaches can result in large-scale greenhouse gas emissions.

Mining and purifying natural graphite can also have devastating environmental impacts. For example, natural graphite is rarely found in veins, and thus mining of natural graphite can require energy-intensive processes, such as repeated crushing, milling, and flotation, to separate graphite flakes from adjacent rock or minerals. In addition, purification of the natural graphite can require acid leaching, including large-scale use of hydrofluoric acid (HF), to remove embedded minerals. The purification process can have devastating environmental impacts on soil, water, and air.

There is a need for more environmentally friendly approaches to producing graphite, for example, to meet the increased needs of the lithium-ion battery industry.

### SUMMARY

To address the aforementioned shortcomings and other problems in graphite production, in certain examples, systems and methods are described for producing graphite using biochar as a carbon source and/or bio-oil as a binder for the carbon source. The graphite can be produced in an electrochemical process in which biochar is formed into a cathode (e.g., using bio-oil as a binder), the cathode is immersed in a molten salt electrolyte, and an electrical potential is applied between the cathode and an anode. Additionally or alternatively, bio-oil can be mixed with a carbon source (e.g., amorphous carbon, pet coke, or calcined coke) and silica, and the mixture can be heated to form graphite.

In one aspect, the subject matter of this disclosure relates to a method of producing graphite from biochar. The method includes: obtaining biochar; forming the biochar into a pellet; immersing the pellet and an anode in a molten salt electrolyte; and applying a voltage difference across the pellet and the anode to form graphite.

In another aspect, the subject matter of this disclosure relates to a system for producing graphite from biochar. The system includes: a reactor vessel containing a molten salt; an anode disposed in the molten salt; a cathode disposed in the molten salt and including biochar; and a power source for applying a voltage across the anode and the cathode, wherein the applied voltage drives an electrolysis reaction that produces graphite.

In another aspect, the subject matter of this disclosure relates to a method of producing graphite. The method includes: providing a carbon source; providing bio-oil; forming a mixture of the carbon source and the bio-oil; and heating the mixture to produce graphite.

In another aspect, the subject matter of this disclosure relates to a system for producing graphite. The system includes: a carbon source; a source of bio-oil; a mixing device for forming a mixture of the carbon source and the bio-oil; and a heating device for heating the mixture to produce graphite.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a schematic diagram of a process for electrochemical graphitization of biochar, in accordance with certain embodiments.

FIG. 2 is a schematic diagram of a reactor vessel for forming graphite sheets through electrochemical graphitization of biochar, in accordance with certain embodiments.

FIG. 3 is a schematic diagram of a reactor vessel and a nozzle for forming carbon nanotubes through electrochemical graphitization of biochar, in accordance with certain embodiments.

FIG. 4 is a schematic diagram of a process (e.g., an Acheson process) for producing graphite from a mixture of bio-oil, a carbon source, and silica, in accordance with certain embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

The Figures (FIGS.) and the following description relate to some embodiments by way of illustration only. It should be noted that from the following discussion alternative embodiments of the structures and methods disclosed herein will be readily recognized as viable alternatives that may be employed without departing from the principles of the present disclosure.

Reference will now be made in detail to specific embodiments, examples of which are illustrated in the accompanying figures. It should be noted that wherever practicable similar or like reference numbers may be used in the figures and may indicate similar or like functionality. The figures depict embodiments of the disclosed window structures or window installation methods for purposes of illustration only. One skilled in the art will readily recognize from the following description that alternative embodiments of the structures and methods illustrated herein may be employed without departing from the principles described herein.

In various examples, the present disclosure relates to methods and systems for performing electrochemical graphitization of biochar in molten salt. The biochar can be derived from pyrolysis of biomass, such as wood or agricultural residues. While biochar can be used as a low energy fuel source or a material for soil amendment, the disclosed methods and apparatus can be used to produce graphite and related value-added products from biochar. For example, through the disclosed electrochemical graphitization of biochar in molten salt, biochar can be converted into (or react to form) lithium-ion battery grade graphite, suitable to meet the needs of the rapidly expanding market for zero-emission electric vehicles. The disclosed techniques for producing graphite are more environmentally friendly and/or require much less energy than previous approaches.

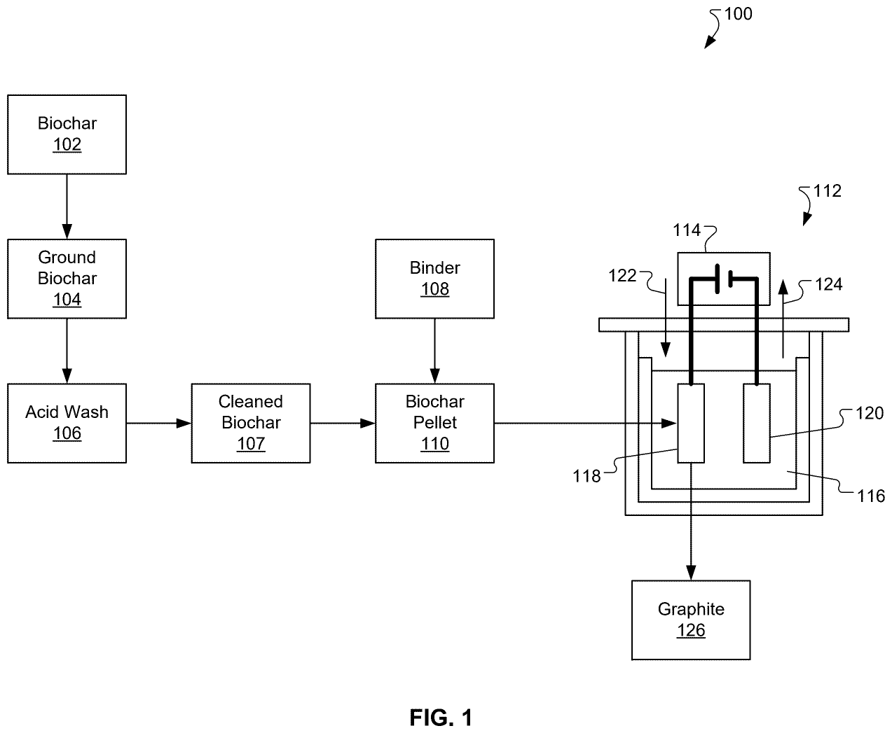

FIG. 1 illustrates an example process 100 for electrochemical graphitization of biochar, in accordance with certain embodiments. Biochar 102 is obtained from a pyrolysis process or other source (e.g., a hydrothermal liquefaction process). The biochar 102 can be subjected to a grinding process that converts the biochar 102 into a ground biochar 104 containing small biochar particles (e.g., less than 30 microns, on average). The ground biochar 104 can be cleaned in an acid wash process 106 (or other process) to remove ash or other impurities and obtain cleaned biochar 107. A binder 108 can be added to the cleaned biochar 107, and the binder 108 and the cleaned biochar 107 can be pressed to form a pellet 110 having a desired shape, such as a cylinder, a rod, a sheet, or a cathode shape. The binder 108 can be or include, for example, bio-oil, tar pitch, a material having a high carbon content and high viscosity (e.g., crude tall oil or other paper/pulp making byproduct), municipal waste, molasses (and other viscous carbonaceous materials), or other suitable binder.

The pellet 110 can be added to an electrolysis reactor 112 where components of the biochar can be converted into or undergo a reaction to form graphite. For example, the pellet 110 can be connected to an electrical source 114, submerged in an electrolyte 116, and used as a cathode 118 (or portion thereof) in the reactor 112. Likewise, an anode 120 (e.g., made of graphite) can be connected to the electrical source 114 and submerged in the electrolyte 116. An inert gas 122 (e.g., argon) can be pumped into the reactor 112 and a mixture of gases 124 (e.g., including the inert gas plus gases produced during electrolysis, such as water vapor, hydrogen, oxygen, and/or nitrogen) can be removed from the reactor 112. In various examples, the electrolyte 116 can be a molten salt, such as molten CaCl₂, KCl, NaCl, MgCl₂, or any combination thereof. In one example, the electrolyte 116 is or includes a eutectic mixture of molten CaCl₂) and another molten salt, such as KCl, NaCl, or MgCl₂. The electrical source 114 (e.g., including a power supply and/or a battery) can apply a voltage across the cathode 118 and the anode 120 to drive an electrolysis reaction that forms graphite (e.g., from carbon in the biochar). Once completed, the cathode 118, which now includes or is made of graphite 126, can be removed from the electrolyte 116, cooled, and washed (e.g., with water to remove salt).

In some examples, the biochar 102 may be obtained by heating biomass in a contained system, such as a pyrolyzer configured for pyrolysis or a reactor configured for hydrothermal liquefaction. The biomass can be or include, for example, harvested plant materials, agricultural waste (e.g., corn stover or herbaceous or woody crop residues), forestry residue (e.g., branches, leaves, non-salvageable timber, slash etc.), woody biomass (e.g., trees, shrubs, bushes, etc.), non-woody biomass (e.g., sugar cane, cereal straw, seaweed, algae, cotton, grass, kelp, soil, etc.), animal manure, and/or processed waste (e.g., cereal husks and cobs, bagasse, nut shells, plant oil cake, sawmill waste, papermill waste, food waste, etc.). The pyrolysis process can involve heating the biomass in a low oxygen environment, such that the biomass thermally decomposes into combustible gases and the biochar 102. The combustible gases may be condensed into a combustible liquid, referred to as bio-oil or pyrolysis oil. The bio-oil can be processed to achieve a higher viscosity, increased tackiness, or other properties that make the bio-oil more suitable for use as the binder 108. Such processing can involve, for example, heating the bio-oil to remove water and/or constituents having lower boiling points. Advantageously, compared to other binders, bio-oil can fill in gaps or voids inside the biochar (e.g., the ground biochar 104) to make the biochar more carbon dense prior to graphitization. The gaps or voids can be filled by contacting or mixing the bio-oil with the biochar, which is generally oleophilic. In some examples, the bio-oil can be produced by hydrothermal liquefaction and/or can alternatively be referred to as biocrude.

In certain embodiments, the biochar 102 may have different structures (e.g., different porosities) and sizes, depending on the biomass materials and/or temperatures used for the pyrolysis process (or other process). For example, biochar obtained from alfalfa stems may have different structures or particle sizes than those obtained from corn cobs. Likewise, biochar obtained from wooden logs or branches may have different structures or particle sizes than those obtained from alfalfa stems or corn cobs.

In various implementations, a variety of grinding techniques may be used to convert the biochar 102 into the ground biochar 104. Such techniques can utilize a grinder that is, for example, a shredder-type, a meatgrinder-type, tamper-based, ball mill-based, and/or roller mill-based. The biochar 102 produced in the pyrolysis process can be cooled (e.g., to around room temperature) before being processed to produce the ground biochar 104.

The acid wash process 106 can involve mixing the ground biochar 104 with an acidic solution to dissolve impurities and/or separate the impurities from the ground biochar 104. The acidic solution can be or include an acid (e.g., sulfuric acid, hydrochloric acid, or phosphoric acid) mixed with water and/or other solvent. The type of acid selected for the acid wash process 106 can depend on the impurities that are targeted for removal. The ground biochar 104 and the acidic solution can be mixed in a tank (e.g., a stirred tank) where the acidic solution lowers the pH of the biochar and causes impurities to dissolve or become soluble. Once cleaned, the biochar can be removed from the acidic solution (e.g., containing the dissolved impurities) through filtration, settling, or other methods. The cleaned biochar may be washed with water (e.g., to adjust pH), dried, and/or further cleaned or processed before being formed into the pellet 110.

In various examples, the impurities removed from the ground biochar 104 during the acid wash process 106 or other processing can include heavy metals, minerals, oxides (e.g., calcium, potassium, magnesium, silicon, or sodium oxide), sulfur, alkali earth metals (e.g., sodium and/or potassium), alkaline earth metals (e.g., calcium and/or magnesium), transition metals (e.g., manganese, zinc, and/or iron), or any combination thereof. Table 1 presents example compositions for the ground biochar 104 and the cleaned biochar 107. Actual biochar compositions can vary depending on the biomass source, pyrolysis process conditions, and/or the cleaning process utilized.

TABLE 1
Example compositions of ground biochar
104 and cleaned biochar 107.

| Component | Ground Biochar 104 | Cleaned Biochar 107 |
|---|---|---|
| Carbon (wt %) | 60 to 89 | 60 to 89 |
| Hydrogen (wt %) | 2 to 3 | 2 to 3 |
| Oxygen (wt %) | 8 to 20 | 8 to 20 |
| Nitrogen (wt %) | 0.3 to 0.9 | 0.3 to 0.9 |
| Sulfur (wt %) | 0.015 to 0.025 | 0.015 to 0.025 |
| Sodium (wt %) | 0.1 | Less than 0.01 |
| Potassium (wt %) | 0.1 to 1 | Less than 0.01 |
| Calcium (wt %) | 0.1 to 10 | Less than 0.01 |
| Magnesium (wt %) | 0.1 to 2 | Less than 0.01 |
| Manganese (wt %) | Less than 0.1 | Less than 0.01 |
| Iron (wt %) | Less than 0.1 | Less than 0.01 |
| Zinc (wt %) | Less than 0.1 | Less than 0.01 |

The pellet 110 can include the biochar (e.g., ground biochar 104 and/or cleaned biochar 107) and the binder 108 in various proportions. The pellet 110 can include, for example, from about 80% to about 90%, to about 95%, to about 98%, or to about 99% of the cleaned biochar 107, by weight. Likewise, the pellet 110 can include, for example, from about 1% to about 2%, to about 5%, to about 10%, or to about 20% of the bio-oil and/or other binder 108, by weight. Other amounts of the biochar and/or the binder 108 can be included in the pellet 110.

In some instances, the molten salt used for the electrolyte 116 can have a temperature of about 1100 K, or from about 1025 K to about 1175 K. Such temperatures are considerably lower than temperatures in other graphitization techniques, such as the Acheson process. This can make the process 100 considerably more energy efficient than previous techniques.

In certain examples, the voltage applied by the electrical source 114 can be from about 1 V to about 100 V, or from about 1 V to about 10 V (e.g., about 2 V). Additionally or alternatively, reaction times for the electrolysis reaction taking place in the reactor 112 can be from about 1 minute to about 10 hours, or from about 3 to 6 hours. In some instances, the electrolysis reactions can convert the biochar (or components thereof) in the pellet 110 into graphite by removing oxygen atoms, which can inhibit graphite formation. Alternatively or additionally, the electrolysis reactions can produce graphite from biochar by diffusing non-graphitized carbon atoms to graphene sheets (e.g., using calcium from the molten salt to form CaC₂ as intermediary product).

After the electrolysis reaction, the cathode 118 containing the graphite 126 can be processed, for example, to convert the graphite 126 into a different form and/or clean the graphite 126. In some instances, for example, the cathode 118 and/or the graphite 126 can be ground or crushed to form a powder or small particles. Additionally or alternatively, the graphite 126 can be subjected to a purification or cleaning process, which can involve rinsing or mixing the graphite 126 with water or other solvent (e.g., in a tank or other washing device). In some instances, the graphite 126 can be washed in a process that is similar or identical to the acid wash process 106 used to remove impurities from the ground biochar 104.

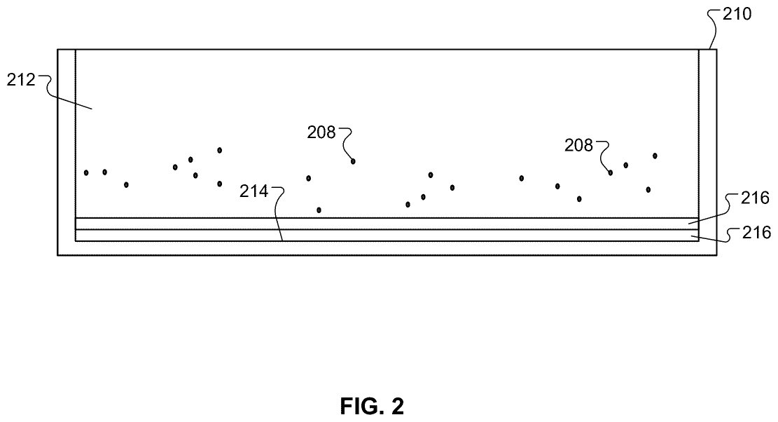

Referring to FIG. 2, in certain examples, a reactor vessel 210 containing a molten salt or other electrolyte 212 can convert particles 208 of biochar into one or more sheets 216 of graphite (e.g., through an electrochemical reaction). In some embodiments, the biochar particles 208 may be added intermittently (e.g., in batches) to the electrolyte 212 (e.g., molten salt) to make the sheets 216. For example, a hopper and/or a feeder device (not shown) can be used to apply the biochar particles 208 to a top surface of the electrolyte 212. The biochar particles 208 can then sink through the electrolyte 212 and accumulate on or over a substrate 214 of the reactor vessel 210. Alternatively or additionally, the biochar particles 208 can be added to a bottom portion of the reactor vessel 210, for example, at or near the substrate 214. The substrate 214 may form a bottom surface of the reactor vessel 210 and/or may be configured to be removed from the vessel 210 along with one or more sheets 216 of graphite. In some examples, a top surface of the substrate can have a surface area of about 100 cm², about 1000 cm², about 10,000 cm², about 100,000 cm², about 1,000,000 cm², or more. An anode and a cathode (not shown) can be included for performing the electrolysis reaction described herein. For example, the substrate 214 or another structure of the reactor vessel 210 may be or may form part of the cathode. In some instances, the anode can be positioned in a sidewall of the reactor vessel 210 and/or can be positioned above the substrate 214, for example, as a horizontal plate, mesh, or rod.

In some embodiments, multiple sheets 216 of graphite can be formed by adding the biochar particles 208 in batches. For example, after a first batch of biochar particles 208 has been added to the substrate 214 and converted into a first sheet 216, a second batch of biochar particles 208 can be added and converted into a second sheet 216. The first and second batches can be separated in time by a waiting period, which can be, for example, about 30 minutes, one hour, 12 hours, or one day. The waiting period can provide time for the biochar particles 208 to form the graphite sheets 216. Any number of sheets 216 can be formed in this manner.

In some embodiments, the graphite sheets 216 may be removed from the substrate 214 (e.g., scraped or peeled off the substrate 214) for further processing. For example, the graphite sheets 216 may be washed (e.g., to remove calcium chloride or other salt or impurities), cut to desired sizes, or crushed or pulverized to form particles.

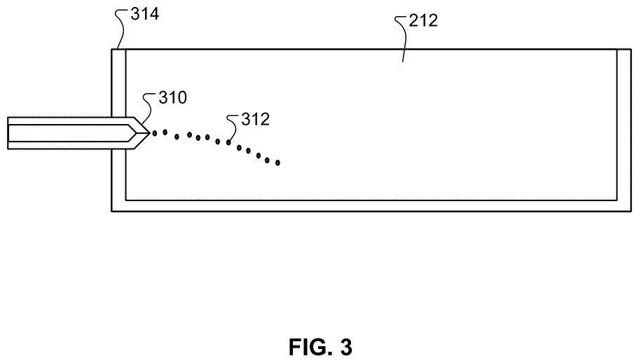

In some embodiments, biochar particles can be added to the electrolyte (e.g., molten salt) using one or more nozzles. For example, as shown in FIG. 3, a nozzle 310 may be used to inject biochar 312 (e.g., as particles or strings) into the electrolyte 212 in a reactor vessel 314. Additionally or alternatively, the injected biochar 312 may form carbon nanotubes during the electrochemical graphitization reaction. The nozzle 310 may be configured to have an orifice corresponding to a desired diameter or size of the carbon nanotubes. For example, if a carbon nanotube with a radius of 50 nm is desired, the orifice may be configured to have a diameter of about 50 nm. Likewise, if a carbon nanotube with a radius of 80 nm is desired, the orifice may be configured to have a diameter of about 80 nm. An anode and a cathode (not shown) can be included for performing the electrolysis reaction described herein. For example, the nozzle 310 may be or may form part of the cathode, such that some or all of the graphitization can occur at or near the nozzle 310. The biochar 312 in such examples can be cleaned (e.g., the cleaned biochar 107) and/or can be mixed with a liquid (e.g., bio-oil) to form a mixture that can pumped or extruded through the nozzle 310.

In some embodiments, the reactor vessel 314 may be configured to use a variety of nozzles having different orifice sizes, such that a corresponding variety of carbon nanotube diameters can be produced. For example, a series of nozzles with different orifice diameters (e.g., 20 nm, 30 nm, 40 nm, 50 nm, 60 nm, 70 nm, 80 nm, 90 nm, 100 nm, etc.) may be configured or developed for use with the reactor vessel 314. The carbon nanotubes may be removed from the reactor vessel 314 and washed or subjected to further processing, as described herein.

In addition to particles, sheets, and/or nanotubes, other forms of graphite can be produced using the systems and methods described herein. For example, the resulting graphite can be in the form of carbon nanofibers, nano particles, spheres, or cylinders. The graphite can be subjected to further processing (e.g., cleaning, grinding, mixing with binders or other ingredients, etc.), formed into spheres or other shapes for batteries, and/or can be incorporated into a variety of products, including batteries for electric vehicles, such as lithium-ion batteries. For example, the graphite (e.g., in particle or powder form) can be mixed with a binder and/or other materials (e.g., silica) and formed into an electrode.

Referring again to FIG. 1, as described herein, bio-oil can be used as the binder 108 to produce the biochar pellet 110 that can be converted into (or react to form) graphite in the electrochemical graphitization process 100. In other examples, bio-oil can be used to form pellets from other carbon sources, in addition to or instead of biochar. Such carbon sources can include for example, petcoke and/or activated charcoal. Like the biochar pellet 110, pellets formed with bio-oil and a carbon source other than or in additional to biochar can be added to the electrolysis reactor 112 where the carbon source can react to form graphite. For example, a pellet having the carbon source can be connected to the electrical source 114, submerged in the electrolyte 116, and used as the cathode 118 in the reactor 112. The electrical source 114 can apply a voltage across the cathode 118 and the anode 120 to drive an electrolysis reaction that converts the carbon source (or components thereof) into graphite, as described herein for the biochar pellet 110.

Additionally or alternatively, bio-oil can be used as a binder in other graphitization processes, such as the Acheson process. In general, the traditional Acheson process is a method of synthesizing silicon carbide (SiC) and graphite. The process can include mixing carbon powder and silica with tar pitch, which serves as a binder, pressing the mixture into a desired shape (e.g., an electrode or crucible), and applying heat. The shaped mixture can be surrounded with granulated carbon acting as a resistive element. In a Castner lengthwise graphitization furnace, for example, items to be graphitized (e.g., rods) can be heated by placing them lengthwise end-to-end in contact with carbon electrodes so that current flows through the items, and the surrounding granulated carbon acts as a thermal insulator. The resistive element can act as a heating device. Other heating devices can be used, including, for example, electricity-based devices or fuel-based devices.

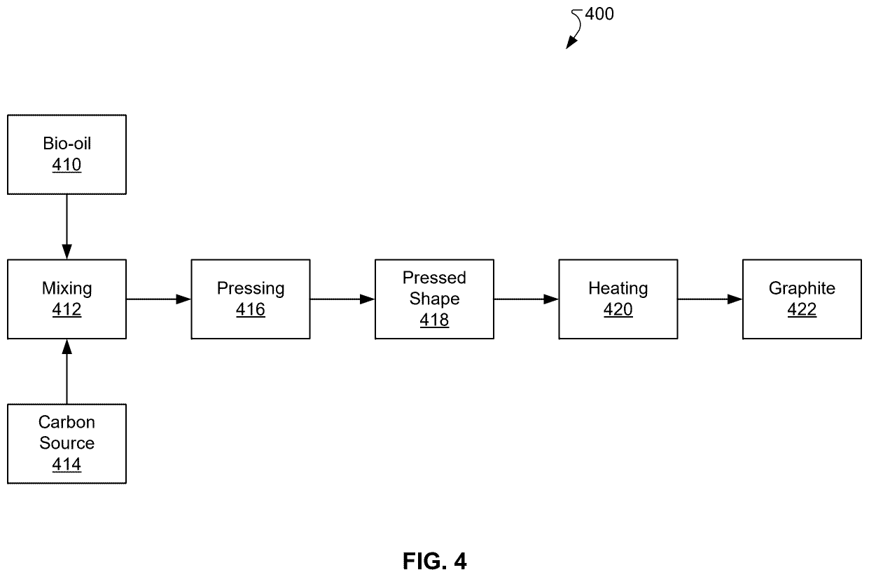

Referring to FIG. 4, in some embodiments, tar pitch can be replaced with bio-oil in a process 400 (e.g., an Acheson process) in which bio-oil 410 is mixed (step 412) with a carbon source 414 (e.g., in particle form) and silica (e.g., sand or quartz), and the mixture is pressed (step 416) into a desired shape 418 (e.g., a block, a cylinder, or a rod) and heated (step 420) to convert the carbon source 414 into graphite 422. The carbon source 414 can be or include, for example, amorphous carbon, pet coke, calcined coke, activated carbon, coal char, carbon black, biochar, or any combination thereof. The mixture can include, for example, about 20% binder (e.g., bio-oil 410 or a combination of bio-oil 410 and tar pitch) and about 80% carbon source, by weight. A variety of mixing devices can be used to mix the bio-oil 410, the carbon source 414, and the silica (or other ingredients), including, for example, a batch mixer, a continuous mixer, a ribbon blender, a planetary mixer, a paddle mixer, a drum mixer, a static mixer, or rotor-stator mixer, or a cone mixer.

In various examples, when bio-oil 410 is used as a binder in the process 400 and/or in the electrochemical graphitization process described herein (e.g., process 100), bio-oil obtained from pyrolysis can be processed to adjust one or more properties of the bio-oil and/or make it more suitable for use as a binder. The bio-oil can be de-watered, for example, by vacuum evaporation and/or by applying heat to evaporate the water. Additionally or alternatively, a viscosity of the bio-oil can be increased by driving off light ends (e.g., by applying heat). In some implementations, the bio-oil 410 can have a water content less than about 5% by mass, a carbon content of at least about 70% by mass, and/or a viscosity (e.g., at room temperature or about 20° C.) from about 1 cSt to about 10,000 cSt, or from about 100 cSt to about 300 cSt, or about 200 cSt.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

The construction and arrangement of the elements of the apparatus as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes, and omissions may be made in the design, operating conditions, and arrangement of the exemplary embodiments without departing from the spirit of the present subject matter.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

It should be also understood that as used in the description herein the meaning of “a,” “an,” and “the” includes plural reference unless the context clearly dictates otherwise. Also, as used in the description herein, the meaning of “in” includes “in” and “on” unless the context clearly dictates otherwise.

Each numerical value presented herein is contemplated to represent a minimum value or a maximum value in a range for a corresponding parameter. Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. A method of producing graphite from biochar, the method comprising:
obtaining biochar;
forming the biochar into a pellet;
immersing the pellet and an anode in a molten salt electrolyte; and
applying a voltage difference across the pellet and the anode to form graphite.

2. The method of claim 1, wherein obtaining the biochar comprises cleaning the biochar in an acid wash process to remove impurities.

3. The method of claim 1, wherein the molten salt electrolyte includes calcium chloride.

4. The method of claim 1, wherein forming the biochar into the pellet comprises mixing the biochar with a binder.

5. The method of claim 4, wherein the binder includes bio-oil.

6. The method of claim 1, further comprising:
removing the graphite from the molten salt electrolyte; and
washing the graphite to remove salt.

7. A system for producing graphite from biochar, the system comprising:
a reactor vessel containing a molten salt;
an anode disposed in the molten salt;
a cathode disposed in the molten salt and comprising biochar; and
a power source for applying a voltage across the anode and the cathode, wherein the applied voltage drives an electrolysis reaction that produces graphite.

8. The system of claim 7, wherein the biochar has been cleaned in an acid wash process to remove impurities.

9. The system of claim 7, wherein the molten salt includes calcium chloride.

10. The system of claim 7, wherein the cathode comprises the biochar mixed with a binder.

11. The system of claim 10, wherein the binder includes bio-oil.

12. The system of claim 7, further comprising a washing device for washing the graphite to remove salt.

13. A method of producing graphite, the method comprising:
providing a carbon source;
providing bio-oil;
forming a mixture of the carbon source and the bio-oil; and
heating the mixture to produce graphite.

14. The method of claim 13, wherein the carbon source comprises at least one of amorphous carbon, pet coke, or calcined coke.

15. The method of claim 13, wherein the bio-oil has a water content less than about 5% by mass, a carbon content of at least about 70% by mass, and a viscosity at room temperature from about 200 cSt to about 300 cSt.

16. The method of claim 13, wherein the mixture comprises silica.

17. A system for producing graphite, the system comprising:
a carbon source;
a source of bio-oil;
a mixing device for forming a mixture of the carbon source and the bio-oil; and
a heating device for heating the mixture to produce graphite.

18. The system of claim 17, wherein the carbon source comprises at least one of amorphous carbon, pet coke, or calcined coke.

19. The system of claim 17, wherein the bio-oil has a water content less than about 5% by mass, a carbon content of at least about 70% by mass, and a viscosity at room temperature from about 200 cSt to about 300 cSt.

20. The system of claim 17, wherein the mixture comprises silica.
